(19) United States
(12) Patent Application Publication
(10) Pub. No.: US 2007/0273814 A1
(43) Pub. Date: Nov. 29, 2007

(54) TRANSFLECTIVE DISPLAY APPARATUS AND METHOD OF MANUFACTURING THE SAME

(76) Inventors: Chun-Gi You, Hwaseong-si (KR); Se-Il Cho, Suwon-si (KR)

Correspondence Address: Frank Chau, Esq.;F. CHAU & ASSOCIATES, LLC, 130 Woodbury Road, Woodbury, NY, 11797, US

(21) Appl. No.: 11/753,948

(22) Filed: May 25, 2007

(30) Foreign Application Priority Data
May 29, 2006 (KR) 2006-48242

(51) Int. Cl. G02F 1/1335

(52) U.S. Cl. 349/114

(57) ABSTRACT

A display apparatus has a plurality of pixel portions. Each of the pixel portions includes a thin-film transistor (TFT), an insulating layer formed on the TFT, a reflective electrode formed on the insulating layer, and a pixel electrode formed on the reflective electrode. The thickness of the insulating layer in a first portion on which only the pixel electrode is formed is different from that of the insulating layer in a second portion on which the reflective electrode is formed. For example, the thickness of the insulating layer in the first portion on which the pixel electrode is formed may be thinner than that of the insulating layer in the second portion that the reflective electrode is formed on.

### CROSS-REFERENCE TO RELATED PATENT APPLICATION

This application claims priority to Korean Patent Application No. 2006-48242, filed on May 29, 2006, in the Korean Intellectual Property Office (KIPO), the disclosure of which is incorporated by reference herein.

### BACKGROUND OF THE INVENTION

1. Technical Field

The present disclosure relates to a transflective display apparatus and a method of manufacturing the transflective display apparatus. More particularly, the present disclosure relates to a transflective display apparatus for reducing image-stickings, and a method of manufacturing the transflective display apparatus.

2. Discussion of the Related Art

Generally, a display apparatus is a type of interface apparatus that transforms data processed by a data processing system into an image that is visible to the naked eye.

Display apparatuses may be classified as cathode ray tube (CRT) display apparatuses or flat panel display (FPD) apparatuses. FPD apparatuses include liquid crystal display (LCD), plasma display panel (PDP), and organic light-emitting display (OLED) apparatuses.

An LCD apparatus may be classified as a transmissive LCD apparatus, a reflective LCD apparatus, or a transflective LCD apparatus. A transmissive LCD apparatus displays an image by using a light source such as a backlight. A reflective LCD apparatus displays an image by using natural light. A transflective LCD apparatus displays an image by using light generated by an internal light source during a transmission display mode and a low illumination state, and displays an image by reflecting an external light source during a reflection display mode and a high illumination state.

A transmissive LCD apparatus includes a backlight disposed under an LCD panel. Light emitted from the backlight passes through the LCD panel to display an image. However, the transmissive LCD apparatus has a low transmission ratio during a high illumination state, making it difficult to view images. A reflective LCD apparatus using an LCD panel having a reflective layer may visibly display an image with an external light source during a high illumination state, but it may be difficult to view the image during a low illumination state.

A transflective LCD apparatus has characteristics of both the transmissive and reflective LCD apparatuses, making it possible to view an image during both the low and high illumination states. Therefore, transflective LCD apparatuses are often used.

FIG. 1 is a cross-sectional view illustrating a conventional transflective LCD apparatus. Referring to FIG. 1, the conventional transflective LCD apparatus includes a pixel electrode 181 directly contacting a drain electrode of a thin-film transistor (TFT), and a reflective electrode 190 formed on the pixel electrode 181 corresponding to a reflective area. The reflective electrode 190 may include a metallic material such as aluminum (Al), or silver (Ag). However, metal ions of the reflective electrode 190 liberated through various chemical reaction processes performed on the reflective electrode 190 tend to induce image-stickings on the display image.

Thus, there is a need for a need for a transflective LCD apparatus that reduces image-stickings,

### SUMMARY OF THE INVENTION

A display apparatus for reducing image-stickings is provided according to an exemplary embodiment of the present invention. The display apparatus has a plurality of pixel portions. Each of the pixel portions include a thin-film transistor (TFT), an insulating layer formed on the TFT, a reflective electrode formed on the insulating layer, and a pixel electrode formed on the reflective electrode. The pixel electrode may cover the entire reflective electrode. The thickness of the insulating layer in a first portion on which only the pixel electrode is formed is different from that of the insulating layer in a second portion on which the reflective electrode is formed. For example, the thickness of the insulating layer in the first portion on which only the pixel electrode is formed may be thinner than that of the insulating layer in the second portion that the reflective electrode is formed on. The pixel electrode may include indium tin oxide (ITO).

A method of manufacturing a display apparatus which reduces image-stickings is provided according to an exemplary embodiment of the present invention. The method includes the steps of forming a gate electrode and a gate pad electrode on a substrate, forming a gate insulating layer on the gate electrode and the gate pad electrode, forming a semiconductor layer on the gate insulating layer, forming a first contact hole in the gate insulating layer to expose the gate pad electrode, depositing a data metal on the semiconductor layer and the gate insulating layer, patterning the data metal to form a source electrode, a drain electrode and a gate pad buffer layer contacting the gate pad electrode through the first contact hole, forming a passivation layer and an insulating layer on the source electrode, the drain electrode and the gate pad buffer layer, forming a second contact hole in the insulating layer on the drain electrode and the gate pad buffer layer to expose the passivation layer, depositing a metal for a reflective electrode on the insulating layer, patterning the metal to form the reflective electrode, patterning the exposed passivation layer through the second contact hole to form third and fourth contact holes exposing the drain electrode and the gate pad buffer layer, depositing a material for a pixel electrode on the reflective layer and the insulating layer, and patterning the material to form the pixel electrode contacting the drain electrode and to form a gate pad pixel electrode contacting the gate pad buffer layer.

The second contact hole and an embossing pattern may be formed in the insulating layer substantially at the same time.

### BRIEF DESCRIPTION OF THE DRAWINGS

The above and other features of the present invention will become more readily apparent by describing in detail exemplary embodiments thereof with reference to the accompanying drawings, in which:

FIG. 1 is a cross-sectional view illustrating a conventional transflective liquid crystal display (LCD) apparatus;

FIG. 2 is a schematic diagram of an LCD apparatus;

FIG. 3 is a cross-sectional view illustrating a transflective LCD apparatus according to an exemplary embodiment of the present invention; and

FIGS. 4 to 12B are cross-sectional views illustrating a method of manufacturing a transflective LCD apparatus according to an exemplary embodiment of the present invention.

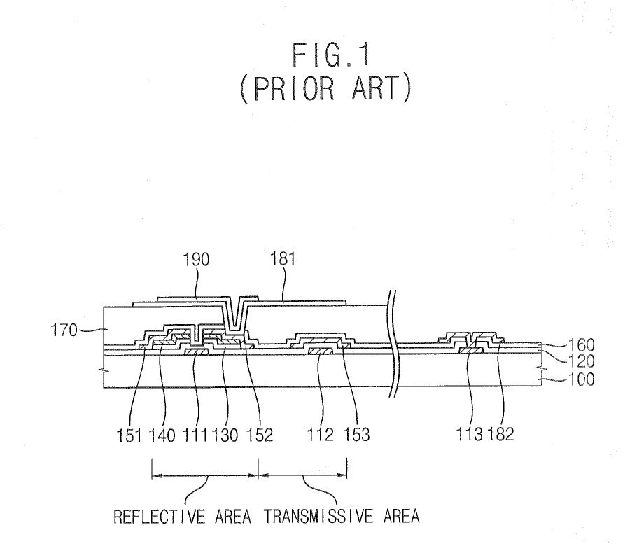

### DETAILED DESCRIPTION OF EXEMPLARY EMBODIMENTS

The invention is described more fully hereinafter with reference to the accompanying drawings, in which embodiments of the invention are shown. This invention may, however, be embodied in many different forms and should not be construed as limited to the embodiments set forth herein. It will be understood that when an element or layer is referred to as being “on,” “connected to” or “coupled to” another element or layer, it can be directly on, connected or coupled to the other element or layer or intervening elements or layers may be present. Hereinafter, exemplary embodiments of the present invention will be explained in more detail with reference to the accompanying drawings.

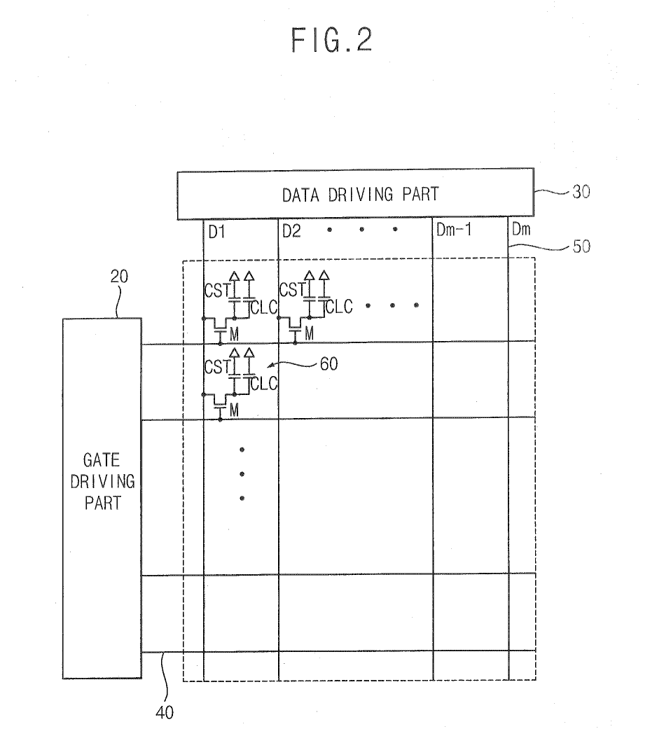

FIG. 2 is a schematic diagram of a liquid crystal display (LCD) apparatus.

Referring to FIG. 2, a plurality of data lines 50 is formed on a substrate along a first direction and each of the data lines 50 is separated from each other by a predetermined distance. A plurality of gate lines 40 is formed on the substrate along a second direction substantially perpendicular to the first direction and each of the gate lines 40 is separated from each other by a predetermined distance.

Each of a plurality of pixel portions 60 is defined by an area that is surrounded by the data lines 50 and the gate lines 40. Each of the pixel portions 60 includes a thin-film transistor (TFT) M, a storage capacitor CST and a liquid crystal capacitor CLC. The TFT M includes a gate electrode, a drain electrode, a source electrode and a semiconductor layer pattern.

The gate electrode of the TFT M is electrically connected to one of the gate lines 40. The source electrode of the TFT M is electrically connected to one of the data lines 50. In addition, the drain electrode of the TFT M is electrically connected to the storage capacitor CST and the liquid crystal capacitor CLC.

When a gate voltage is applied to the gate electrode, the TFT M is turned on. When the TFT M is turned on, a pixel voltage of one of the data lines 50 is applied to the storage capacitor CST and the liquid crystal capacitor CLC through the TFT M. The liquid crystal capacitor CLC includes a common electrode and a pixel electrode. Liquid crystal molecules are disposed between the common electrode and the pixel electrode. When the pixel voltage is applied to the liquid crystal capacitor CLC, the direction of the liquid crystal molecules changes, which in turn changes the optical characteristics of the molecules, thereby causing an image to be displayed.

The storage capacitor CST prevents a data voltage applied to the pixel electrode of the liquid crystal capacitor CLC from being changed after the data voltage is applied to the liquid crystal capacitor CLC.

The pixel electrode of the liquid capacitor CLC may include, for example, indium tin oxide (ITO) or indium zinc oxide (IZO).

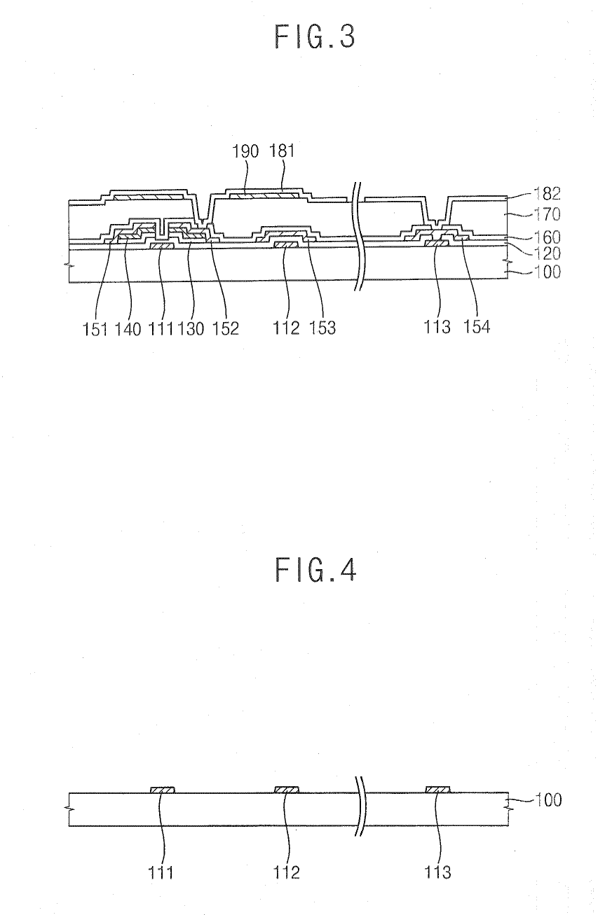

FIG. 3 is a cross-sectional view illustrating a transflective LCD apparatus according to an exemplary embodiment of the present invention.

FIG. 3 shows cross-sections of the TFT, the storage capacitor CST and a gate pad portion of each of the pixel portions 60.

The TFT M includes a gate electrode 111, a semiconductor layer 130, an ohmic contact layer 140, a source electrode 151 and a drain electrode 152.

The gate electrode 111 is electrically connected to each of the gate lines 40, for transferring a signal that is applied from a gate driving part 20 to the TFT M.

A gate insulating layer 120 is formed on the gate electrode 111 for insulating the gate electrode 111 from the semiconductor layer 130. The gate insulating layer 120 may include, for example, silicon oxide (SiOx) or silicon nitride (SiNx).

The semiconductor layer 130 may include, for example, amorphous silicon, or polycrystalline silicon. The semiconductor layer 130 operates as a channel layer of the TFT M. The transflective LCD apparatus in FIG, 3 corresponds to a bottom gate structure having the semiconductor layer 130 disposed on the gate electrode 111. However, the transflective LCD apparatus may employ a top gate structure having the semiconductor layer 130 disposed under the gate electrode 111.

The ohmic contact layer 140 is formed on the semiconductor layer 130. The ohmic contact layer 140 may include a silicon layer having phosphorus (P) for preventing the leaking of an off-current from the semiconductor layer 130.

The source electrode 151 is formed on the semiconductor layer 130 and the ohmic contact layer 140, and is electrically connected to each of the data lines 50. The source electrode 151 receives the data signal from the data driving part 30, and transfers the data signal to the TFT M.

The drain electrode 152 is formed to face the source electrode 151 and the channel layer of the TAT M is disposed between the drain electrode 152 and the source electrode 151. The drain electrode 152 receives the data signal from the source electrode 151, and transfers the data signal to the pixel electrode,

As the size and resolution of the substrate increases, the resistance of the material employed by the source electrode 151 and the drain electrode 152 decreases. Materials that can be used for the source and drain electrodes 151 and 152 may include, for example, aluminum (Al), copper (Cu), molybdenum (Mo), titanium (Ti), or alloys thereof.

A passivation layer 160 and an insulating layer 170 are formed on the TFT M including the gate electrode 11X, the semiconductor layer 130, the source electrode 151 and the drain electrode 152. The passivation layer 160 and the insulating layer 170 include a contact hole through which the drain electrode 152 and the pixel electrode 181 are electrically connected to each other.

Materials that can be used for the passivation layer 160 may include, for example, silicon oxide (SiOx) or silicon nitride (SiNx).

The insulating layer may include an embossing pattern (not shown). The embossing pattern is formed at a first portion corresponding to a reflective area that reflects light incident from the exterior. The embossing pattern is shaped to reflect the light incident from the exterior to a predetermined direction. A second portion of the insulating layer, which corresponds to a transmissive region that transmits the light incident from a light source under a display panel, does not include the embossing pattern. The thickness of the insulating layer 170 on which only the pixel electrode 181 is formed may be thinner than that of the insulating layer 170 under a reflective electrode 190 and the pixel electrode 181.

The reflective electrode 190 is formed on the insulating layer 170 having the embossing pattern, which corresponds to the reflective area of each of the pixel portions. The reflective electrode 190 includes materials that can reflect the light incident from the exterior, and includes a single metallic layer or an alloy having, for example, aluminum (Al). The transparent pixel electrode 181 is formed on the reflective electrode 190 and is formed on the second portion of the insulating layer 170 not including the embossing pattern. The pixel electrode 181 is electrically connected to the drain electrode 152 of the TFT M through the contact hole that is formed in the insulating layer 170 and the passivation layer 160. The pixel electrode 181 may include, for example, amorphous indium tin oxide (a-ITO).

The reflective electrode of a conventional pixel electrode which includes oxidized ITO becomes corroded due to a battery effect when oxidized ITO contacts aluminum used for the reflective electrode. This corrosion is prevented by forming a buffer layer between the pixel electrode and the reflective electrode. Since the buffer layer includes an opaque metal, the pixel electrode is formed under the reflective electrode in the transflective display apparatus, and metal ions of the reflective electrode liberated through various chemical reactions on the reflective electrode, cause image-stickings to be displayed.

As mentioned above, the pixel electrode according to the present exemplary embodiment includes a-ITO. Since water vapor (H₂O) is intentionally injected into a chamber in a depositing process, a-ITO includes more hydroxyl radical (OH) than oxidized ITO used in the conventional pixel electrode.

The hydroxyl radical (OH) is disposed around a crystal of an oxidized ITO alloy to decrease the battery effect when oxidized ITO contacts aluminum. For example, a standard deoxidation voltage of ITO used for the conventional pixel electrode is about −0.82 V but the standard deoxidation voltage of a-ITO used for the pixel electrode of the present exemplary embodiment is about −1.39 V. The electromotive force of a-ITO is about one fourth that of aluminum, which has a standard deoxidation voltage of about −1.58 V. Thus, the pixel electrode 181 may directly contact the reflective electrode 190 without the opaque buffer layer of a conventional transflective display apparatus.

The storage capacitor CST includes a supplemental capacity gate electrode 112, a gate insulating layer and a supplemental capacity data electrode 153. The storage capacitor CST maintains the data voltage applied to the pixel electrode for one frame after the gate electrode 111 is turned off.

The supplemental capacity gate electrode 112 may be formed from the same layer as the gate electrode 111. The storage capacitor CST may correspond to an independent line type storage capacitor CST, in which, the supplemental capacity gate electrode 112 is separably formed with the gate electrode. However, the supplemental capacity gate electrode 112 may employ a previous gate type in which a portion of a previous gate line is overlapped with the supplemental capacity data electrode 153.

The gate insulating layer 120 is formed on the supplemental capacity gate electrode 112 for insulating the capacitor.

The supplemental capacity data electrode 153 is formed on the gate insulating layer 120. The supplemental capacity data electrode 153 is formed from the same layer and includes the same material as the source electrode 151 and the drain electrode 152 of the TFT.

The gate pad portion includes a gate pad electrode 113., a gate pad buffer layer 154 and a gate pad pixel electrode 182. The gate pad portion is formed at an end portion of each of the gate fines 40 for transferring the gate voltage applied from the exterior to the TFT M.

The gate pad electrode 113 may be formed from the same layer as the gate electrode 111 and the supplemental capacity gate electrode 112.

The gate insulating layer 160 and the gate pad buffer layer 154 are formed over the gate electrode 111. The gate pad buffer layer 154 may be formed from the same layer and include the same material as the source electrode 151, the drain electrode 152 and the supplemental capacity data electrode 153. The gate pad buffer layer 154 is electrically connected to the gate pad electrode 113 through the contact hole that is formed in the gate insulating layer 120.

The passivation layer 160, the insulating layer 170 and gate pad pixel electrode 182 are sequentially formed on the gate pad buffer layer 154. The gate pad pixel electrode 182 and the pixel electrode 181 both include a-ITO. The gate pad pixel electrode 182 is electrically connected to the gate pad buffer layer 154 through the contact hole that is formed in the insulating layer and the passivation layer.

The gate pad pixel electrode 182 is electrically connected to the gate driving s part 20 illustrated in FIG. 2 for applying the gate voltage to each of the gate lines 40.

FIGS. 4 to 12B are cross-sectional views illustrating a method for manufacturing a transflective LCD apparatus according to an exemplary embodiment of the present invention.

Referring to FIG. 4, the gate line, the gate electrode 111, the supplemental capacity gate electrode 112 and the gate pad electrode 113 are formed on the substrate 100.

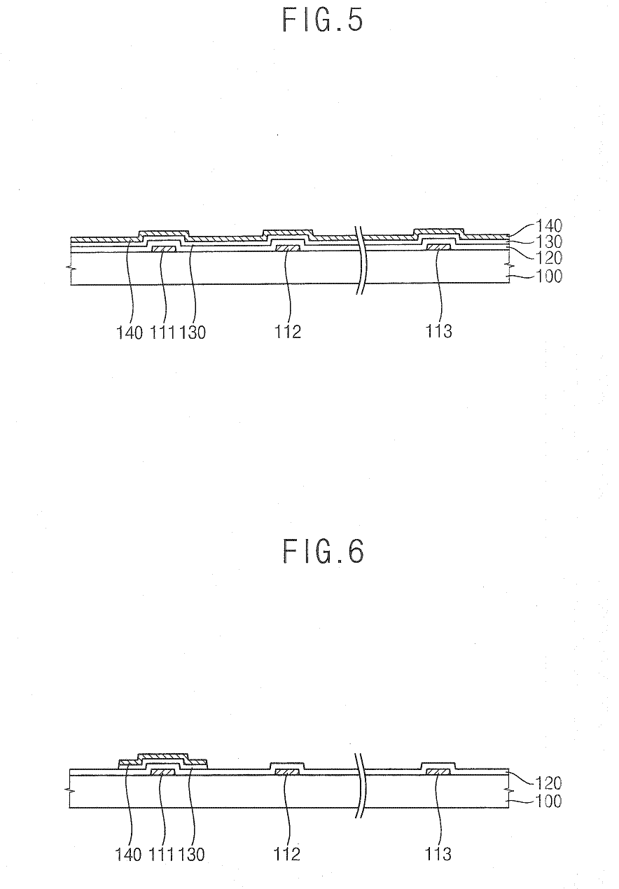

Referring to FIG. 5, the gate insulating layer 120, the semiconductor layer 130 and the ohmic contact layer 140 are then sequentially formed on the gate electrode 111, the supplemental capacity gate electrode 112 and the gate pad electrode 113. The semiconductor layer 130 may include, for example, an amorphous silicon layer or a polycrystalline silicon layer.

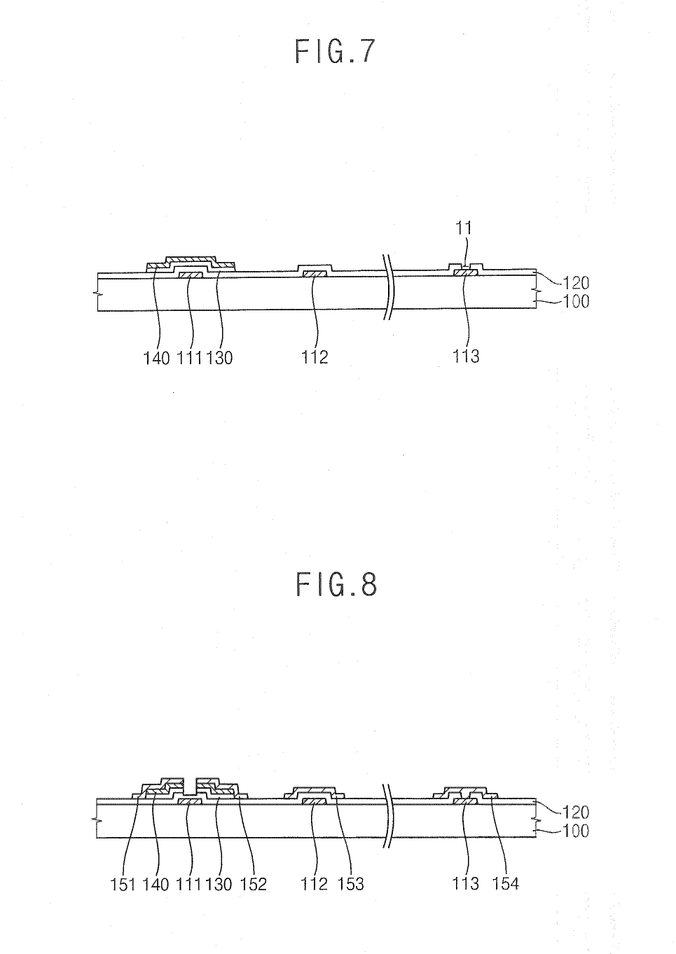

Referring to FIGS. 6 and 7, the semiconductor layer 130 and the ohmic contact layer 140 are then patterned. A first contact hole 11 is formed at the gate insulating layer 120 of the gate pad portion for exposing the gate pad electrode 113 to the exterior. Then, data metal is deposited on the semiconductor layer 130, the ohmic contact layer 140 and the gate insulating layer 120.

Referring to FIG. 8, the data line, the source electrode 151, the drain electrode 152, the supplemental capacity data electrode 153 and the gate pad buffer layer 154 are then formed.

The source electrode 151 is formed to face the drain electrode 152, and the channel area of the semiconductor layer is disposed between the source electrode 151 and the drain electrode 152. The ohmic contact layer 140 is separably patterned so that the channel area may be disposed between the ohmic contact layers 140.

As illustrated in FIGS. 5 to 8, the semiconductor layer 130 and the source and drain electrodes 151 and 152 are formed by using different masks, however, the semiconductor layer 130 and the source and drain electrodes 151 and 152 may be formed by using the same mask.

The gate pad buffer layer 154 is electrically connected to the gate pad electrode 113 through the first contact hole 11 that is formed at the gate insulating layer 120 of the gate pad portion.

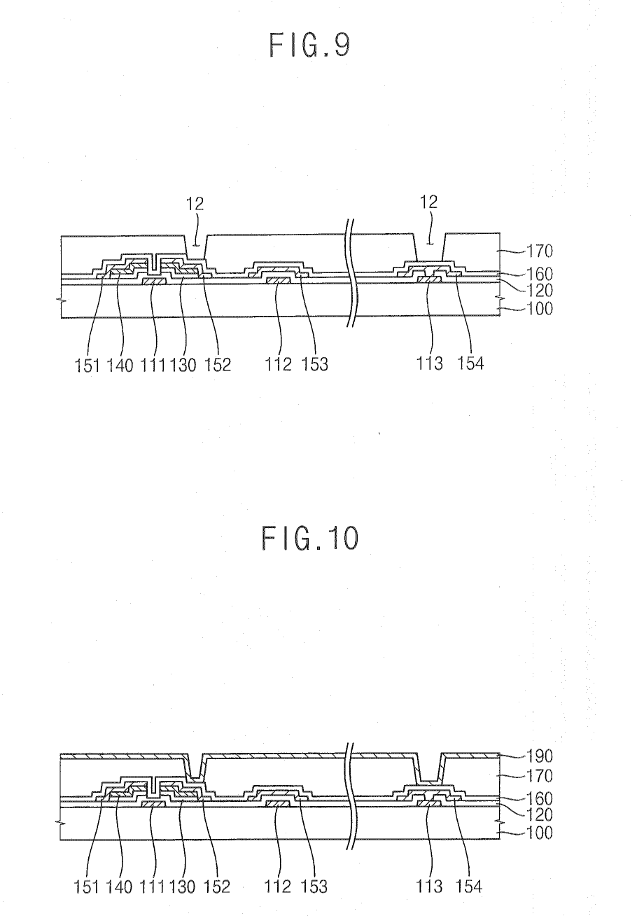

Referring to FIG. 9, the passivation layer 160 and the insulating layer 170 are then sequentially formed on the source electrode 151, the drain electrode 152, the supplemental capacity data electrode 153 and the gate pad buffer layer 154.

A second contact hole 12 is formed at the insulating layer 170 for exposing the passivation layer 160 corresponding to the drain electrode 152 and the gate pad buffer layer 154 to the exterior. The embossing pattern (not shown) may be formed at a portion corresponding to the reflective area by substantially the same process as forming the second contact hole 12 in the insulating layer.

Referring to FIG. 10, the reflective electrode 190 is then formed on the insulating layer 170. The reflective electrode 190 may include, for example, a single metal layer or an alloy having aluminum (Al) or silver (Ag), which are highly reflective to light incident from the exterior.

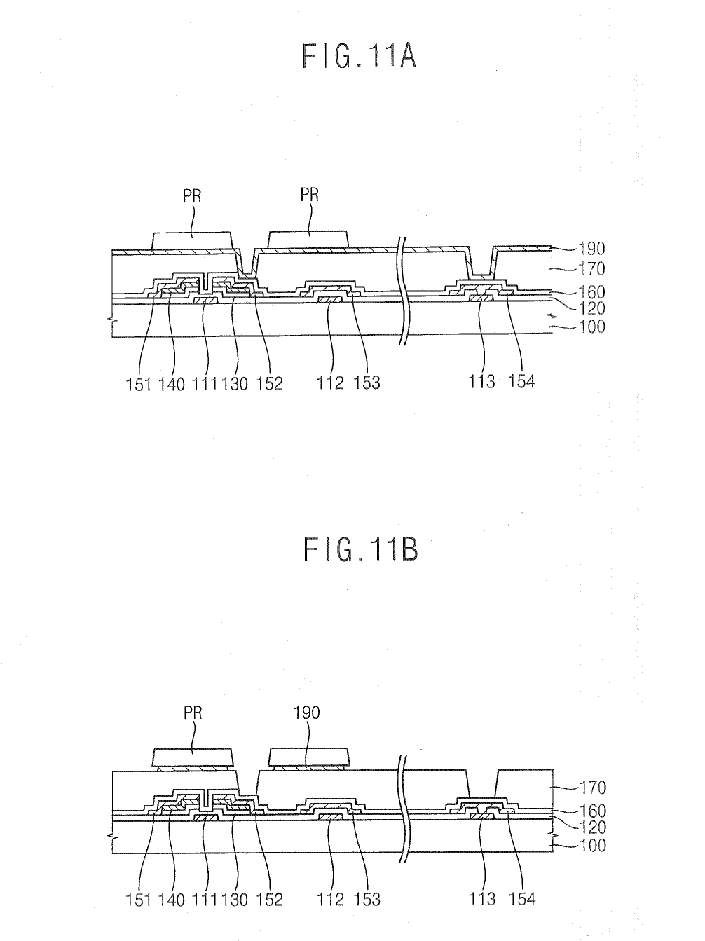

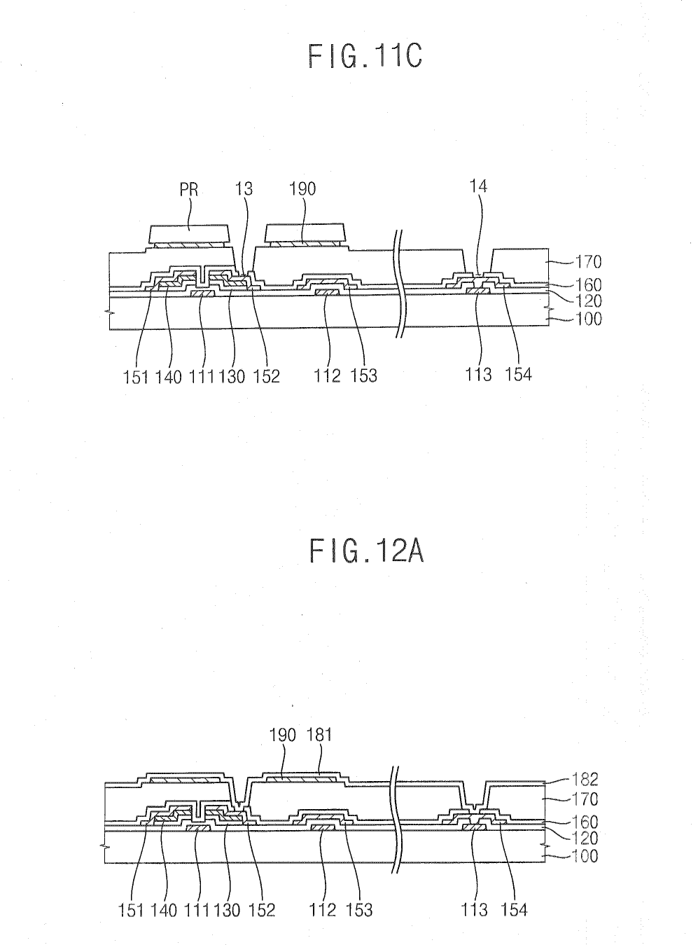

Referring to FIG. 11A, a photoresist layer PR is deposited on the reflective electrode 190, and the photoresist layer PR is patterned by exposing the photoresist layer PR to light such as an ultraviolet ray passing through the mask.

Referring to FIG. 11B, the reflective electrode 190 is then etched using the patterned photoresist layer PR to form the reflective electrode in the reflective area of each of the pixel portions.

Referring to FIG. 11C, a third contact hole 13 and a fourth contact hole 14 are then formed at the passivation layer 160 that is exposed through the second contact hole 12 formed in the insulating layer, for exposing the drain electrode 152 of TFT and the gate pad buffer layer 154 of the gate pad portion to the exterior. The third and fourth contact holes 13 and 14 are formed by etching the passivation layer 160 through the second contact hole 12. The passivation layer 160 may be formed to have a predetermined pattern by a dry etching process.

The thickness of the insulating layer 170 not having the reflective electrode 190 formed thereon may be formed to have a lower thickness than that of the insulating layer 170 having the reflective electrode 190 formed thereon, through the etching process of forming the third and fourth contact holes 13 and 14 at the passivation layer. For example, an upper portion of the insulating layer 170 not having the reflective electrode 190 formed thereon may be partially etched by a dry etching process of forming the third and fourth contact holes 13 and 14 at the passivation layer 160, so that the thickness of the insulating layer 170 not having the reflective electrode 190 formed thereon may be formed to have a lower thickness than that of the insulating layer 170 having the reflective electrode 190 formed thereon. The reflective electrode of the transflective display apparatus is formed adjacent to a data and gate line. Thus: a thickness of the insulating layer on which only the pixel electrode 181 is formed that are divided by the data and gate lines may be thinner than that of the insulating layer having the reflective electrode formed thereon.

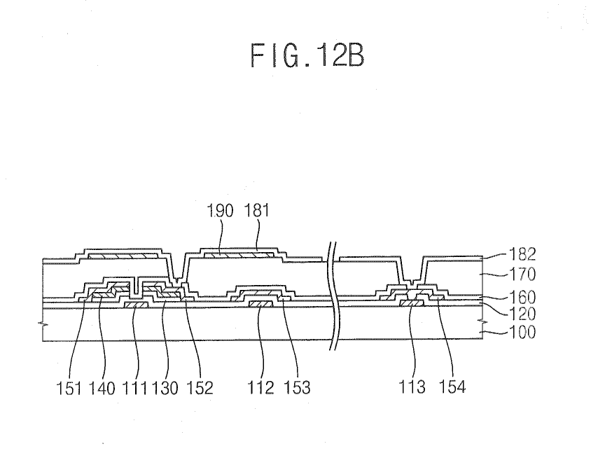

Referring to FIG. 12A, a metallic layer 180 is then deposited on the insulating layer 170 to form the reflective electrode 190. The metallic layer 180 for the pixel electrode includes a-ITO.

Referring to FIG. 128, the metallic layer 180 for the pixel electrode is patterned to form the pixel electrode 181 and the gate pad pixel electrode 182.

A lower substrate including the TFT M is formed using the method of manufacturing a display apparatus mentioned above. Then, the lower substrate is combined with an upper substrate including a color filter and a common electrode corresponding to the pixel electrode, and a liquid crystal layer is interposed between the upper and lower substrates.

Although exemplary embodiments of the present invention have been described, it is to be understood that the present invention should not be construed as limited to these exemplary embodiments, but various changes and modifications can be made by those of ordinary skill in the art within the spirit and scope of the present invention as hereinafter claims.

What is claimed is:

1. A display apparatus having a plurality of pixel portions, the pixel portions comprising:
a thin-film transistor (TFT);
an insulating layer formed on the TFT;
a reflective electrode formed on the insulating layer; and
a pixel electrode formed on the reflective electrode,
wherein a thickness of the insulating layer in a first portion on which only the pixel electrode is formed is different from that of the insulating layer in a second portion on which the reflective electrode is formed,

2. The display apparatus of claim 1, wherein the pixel electrode covers the entire reflective electrode.

3. The display apparatus of claim 1, wherein the thickness of the insulating layer in the first portion on which the pixel electrode is formed is thinner than that of the insulating layer in the second portion on which the reflective electrode is formed.

4. The display apparatus of claim 3, wherein the pixel electrode includes amorphous indium tin oxide (a-ITO).

5. The display apparatus of claim 3, wherein the pixel electrode makes direct contact with a drain electrode of the TFT.

6. The display apparatus of claim 3, further comprising a gate pad portion, the gate pad portion comprising:
a gate pad electrode formed from a same layer as a gate electrode of the TFT;
a gate insulating layer formed on the gate pad electrode and including a first contact hole;
a gate pad buffer layer formed on the gate insulating layer and making contact with the gate pad electrode through the first contact hole;
a passivation layer formed on the gate pad buffer layer and including a second contact hole; and
a gate pad pixel electrode formed on the passivation layer and making contact with the gate pad buffer layer through the second contact hole.

7. The display apparatus of claim 6, wherein the gate pad electrode includes amorphous indium tin oxide (a-ITO).

8. The display apparatus of claim 7, wherein the reflective electrode is formed on the insulating layer having an embossing pattern.

9. The display apparatus of claim 7, wherein source and drain electrodes of the TFT include molybdenum (Mo) or aluminum (Al).

10. A method of manufacturing a display apparatus: the method comprising:
forming a gate electrode and a gate pad electrode on a substrate;
forming a gate insulating layer on the gate electrode and the gate pad electrode;
forming a semiconductor layer on the gate insulating layer;
forming a first contact hole in the gate insulating layer, to expose the gate pad electrode;
depositing a data metal on the semiconductor layer and the gate insulating layer;
patterning the data metal to form a source electrode a drain electrode and a gate pad buffer layer contacting the gate pad electrode through the first contact hole;
forming a passivation layer and an insulating layer on the source electrode, the drain electrode and the gate pad buffer layer;
forming a second contact hole in the insulating layer on the drain electrode and the gate pad buffer layer to expose the passivation layer to the exterior;
depositing a metal for a reflective electrode on the insulating layer;
patterning the metal to form the reflective electrode;
patterning the passivation layer exposed through the second contact hole, to form third and fourth contact holes exposing the drain electrode and the gate pad buffer layer, respectively;
depositing a material for a pixel electrode on the reflective layer and the insulating layer; and
patterning the material to form a pixel electrode contacting the drain electrode and to form a gate pad pixel electrode contacting the gate pad buffer layer.

11. The method of claim 10, wherein the second contact hole and an embossing pattern is formed in the insulating layer substantially at the same time.

12. The method of claim 10, wherein the semiconductor layer includes one of amorphous silicon and polycrystalline silicon.

13. The method of claim 10, wherein the reflective electrode includes one of aluminum and silver.

14. The method of claim 10, wherein the material includes amorphous indium tin oxide (a-ITO).

15. The method of claim 10, further comprising:
combining the substrate with an upper substrate, wherein the upper substrate includes a color fitter, a common electrode, and a common electrode corresponding to the pixel electrode; and
interposing a liquid crystal layer between the substrate and the upper substrate.
